(19) United States
(12) Patent Application Publication
(10) Pub. No.: US 2018/0130004 A1
(43) Pub. Date: May 10, 2018

(54) Assess Quality of Events

(71) Applicant: Edge Strategic Consulting LLC, Edmond, OK (US)

(72) Inventor: Jeffrey Scott Morgheim, Edmond, OK (US)

(21) Appl. No.: 15/344,341

(22) Filed: Nov. 4, 2016

(51) Int. Cl. G06Q 10/06

(52) U.S. Cl. CPC G06Q 10/06395; G06F 19/3431

(57) ABSTRACT

Various implementations described herein are directed to a method for assessing quality of events. The method may include defining an event, defining a quality assessment for the event, and defining factors for the event in association with the quality assessment. The method may include characterizing a factor-quality assessment relationship between each factor and the quality assessment. The method may include determining weighted constraints for applying to each factor-quality assessment relationship. The method may include calibrating the quality assessment based on at least one of the factor-quality assessment relationships and the weighted constraints. The method may include applying the calibrated quality assessment to one or more other events.

### BACKGROUND

This section is intended to provide information relevant to understanding the various technologies described herein. As the section's title implies, this is a discussion of related art that should in no way imply that it is prior art. Generally, related art may or may not be considered prior art. It should therefore be understood that any statement in this section should be read in this light, and not as any admission of prior art.

In modern industries, health, safety, and environmental events of varying levels of severity occur daily within organizations, ranging from near misses to first aid events to fatalities. Organizations seeking to improve performance recognize that within some events are high potential events where a change in factors could have transformed a minor event into a catastrophic event. However, the volume of events can be substantial, staff resources can be limited, and management and staff can carry natural human bias due to a variety of experiences, skills, and training. This unintended bias regarding the characterization of incidents as high potential events can result in varying inconsistent human assessments of potentially severe incidents. This inconsistency can drive a misallocation of investigative efforts and deprive organizations of the capability to learn from minor events, identify and execute corrective actions, and miss an opportunity to inhibit and mitigate the impact of potential catastrophic events.

Some organizations have attempted to use tools, such as risk matrices and scorecards to assess severity potential of events. However, these common tools are typically cumbersome, subjective, numerically unsound, discount human bias, and cannot be carried out systematically at scale. Further, these existing tools for analytics may not be applied to health, safety, and environmental events because significant events can be relatively infrequent, the decisions of whether an event could have high potential need significant expert judgment, and data to inform the decision is either non-existent or inconsistent.

Further, some organizations may also engage in development plan designs and portfolio selection. However, current optimization techniques can make it difficult to find solutions that provide maximization of a single value subject to numerous constraints, such as, e.g., spending, timing, etc. Thus, results can refer to a reworking of constraints without consideration of trade-off values of changing constraints, or a reworking of asset performance assumption. Unfortunately, this can lead to inconsistent decision-making for plans and portfolios and increased delivery risk for organizations.

### SUMMARY

Described herein are various implementations of a method. The method may include defining an event, defining a quality assessment for the event, and defining factors for the event in association with the quality assessment. The method may include characterizing a factor-quality assessment relationship between each factor and the quality assessment. The method may include determining weighted constraints for applying to each factor-quality assessment relationship. The method may include calibrating the quality assessment based on at least one of the factor-quality assessment relationships and the weighted constraints. The method may include applying the calibrated quality assessment to one or more other events.

Described herein are various implementations of a method. The method may include defining an event based on user input, defining a quality assessment for incident severity of the event based on the user input, and defining one or more contribution factors for the event in association with the quality assessment for incident severity based on the user input. The method may include characterizing a factor-quality assessment relationship between each contribution factor and the quality assessment for incident severity based on the user input. The method may include determining weighted constraints for multiple levels of incident severity for applying to each factor-quality assessment relationship, wherein the weighted constraints for each level of the multiple levels of incident severity are based on the user input related to expert judgement of the user. The method may include calibrating the quality assessment for incident severity of the event based on the factor-quality assessment relationships and the weighted constraints for each level of the multiple levels of incident severity. The method may include applying the calibrated quality assessment to one or more other events to provide another quality assessment for incident severity of the one or more other events.

Described herein are various implementations of a method. The method may include defining a financial event based on user input, defining a quality assessment for accelerating growth performance associated with the financial event based on the user input, and defining condition factors for the financial event in association with the quality assessment for accelerating growth performance based on the user input. The method may include characterizing a factor-quality assessment relationship between each condition factor and the quality assessment for accelerating growth performance based on the user input. The method may include determining weighted constraints for multiple levels of accelerating growth performance for applying to each factor-quality assessment relationship, wherein the weighted constraints for multiple levels of accelerating growth performance are based on user input related to expert judgement of the user. The method may include calibrating the quality assessment for accelerating growth performance based on the weighted constraints for the multiple levels of accelerating growth performance. The method may include applying the calibrated quality assessment for accelerating growth performance to one or more other financial events to thereby assess quality for the one or more financial events having a similar nature.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Moreover, the claimed subject matter is not limited to implementations that solve any or all disadvantages noted in any part of this disclosure.

### BRIEF DESCRIPTION OF THE DRAWINGS

Implementations of various techniques are described herein with reference to the accompanying drawings. It should be understood, however, that the accompanying drawings illustrate only various implementations described herein and are not meant to limit embodiments of various techniques described herein.

FIG. 1 illustrates a block diagram of an apparatus for assessing quality of events in accordance with various implementations described herein.

FIG. 2 illustrates a block diagram of components utilized for assessing quality of events in accordance with various implementations described herein.

FIGS. 3A-3E illustrate process flow diagrams of methods for assessing quality of events in accordance with various implementations described herein.

FIG. 4 illustrates a process flow diagram of a method for calculating a quality assessment value in accordance with various implementations described herein.

FIGS. 5-7 illustrate process flow diagrams of methods for assessing quality of events in accordance with various implementations described herein.

FIG. 8 illustrates a block diagram of a computing system in accordance with various implementations described herein.

### DETAILED DESCRIPTION

Various implementations described herein are directed to assessing quality of events. In some implementations, various methods and techniques described herein may be applied to risk assessment, financial assessment, quality assessment, occupational hazards, optimization, decision-making, expert rules, expert judgement, etc. Methods and techniques described herein may enable users to make consistent assessments and predictions of situations or events that are either relatively infrequent or heterogeneous, or data used to inform the assessments are either scarce or inconsistent. The methods and techniques described herein may deliver this by mimicking human-decision-making through innovative modifications of fuzzy mathematic algorithms and providing for user calibration. The methods and techniques described herein may provide a dense package of processes and algorithms that work together to provide a versatile, rapid, calibrated, transparent, and user-friendly way to consistently assess a large number of situations and events based on expert judgment of a user. While the methods and techniques described herein may be used for a substantial number of applications, the more innovative uses may include the assessment of incident severity, pre-job hazards, and providing non-linear optimization to support portfolio selection and development plan design.

In some implementations, the methods and techniques described herein allow expert judgment to be applied to one or more events in a consistent manner regardless of the level of subjectivity of the determination for high potential or the lack of data quantity or quality. The result may thus be a more safe, compliant, and efficient organization that may improve health, safety, and environmental performance, reduce minor events, and reduce occurrence, impact, and/or severity of significant events. Further, in some other implementations, the methods and techniques described herein allow expert judgment to combine goals and constraints into a single quality score and apply physical constraints to plan and portfolio design. The result may provide more consistent plans and thus more robust portfolio selections for reduced delivery risk in some organizations.

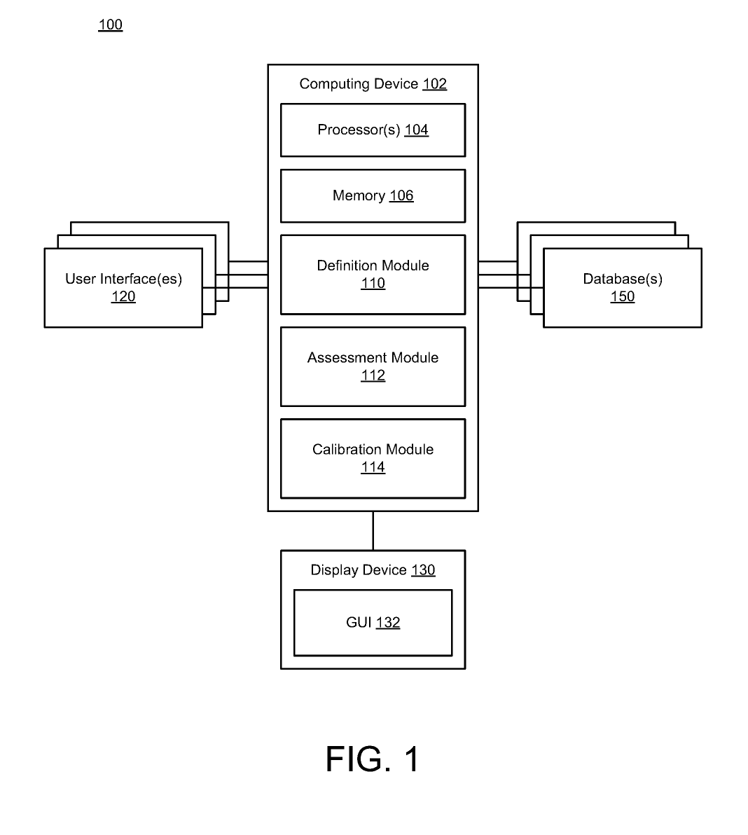

Various implementations of assessing quality of an event will now be described in detail herein with reference to FIGS. 1-8.

FIG. 1 illustrates a block diagram of an apparatus 100 for assessing quality of events in accordance with various implementations described herein.

In reference to FIG. 1, the apparatus 100 may be implemented as a computer system or computing device 102 for assessing quality of events, thereby transforming the computing device 102 into a special purpose machine dedicated to assessing quality of events, as described herein. Thus, in various implementations, the computing device 102 may include standard element(s) and/or component(s), including at least one processor(s) 104, memory 106 (e.g., non-transitory computer-readable storage medium), peripherals, power, and various other computing elements and/or components that are not specifically shown in FIG. 1. Further, as shown in FIG. 1, the apparatus 100 may be associated with a display device 130 (e.g., a monitor or other display) that may be used to provide a graphical user interface (GUI) 132. In some implementations, the GUI 132 may be used to receive input from a user (e.g., user input) associated with assessing quality of events with the apparatus 100. In some other implementations, one or more other user interfaces (UI) 120 (e.g., a keyboard or similar) may be used to receive input from a user (e.g., user input) associated with assessing quality of events with the apparatus 100. The apparatus 100 may also be associated with one or more databases (e.g., database(s) 150) that may be configured to store data and information related to assessing quality of events.

Accordingly, the apparatus 100 may thus include the computing device 102 and instructions recorded on the computer-readable medium 106 (or one or more databases 150) and executable by the at least one processor 104. The apparatus 100 may include the display device 130 for providing output to a user, and the display device 130 may include the GUI 132 for receiving input from the user. Further, one or more UIs 120 may be used for receiving input from the user.

The computing device 102 may include one or more modules, such as, e.g., a definition module 110. In some implementations, the definition module 110 may be used to define an event and define a quality assessment for the event. The event may include at least one of a health event, a safety event, a security event, an environmental event, and a financial event. The event may be defined based on user input, and the quality assessment for the event may be defined based on the user input. The event may include one or more events for which a user seeks to make or perform the quality assessment, and the quality assessment may include one or more various parameters, such as, e.g., characteristics, attributes, and/or qualities of the event for the quality assessment.

The definition module 110 may be used to define one or more factors for the event in association with the quality assessment. In some implementations, the user may identify factors to inform the quality assessment for the events. For instance, a factor may include a height from which an object fell for a safety invent involving a dropped object. For a financial portfolio, a factor may include a level of capital to spend in a given a year.

The computing device 102 may include an assessment module 112. In some implementations, the assessment module 112 may be used to characterize a factor-quality assessment relationship between each factor and the quality assessment. The factor-quality assessment relationship may refer to the factors and their relationship associated with informing or providing information for quality assessment. The assessment module 112 may be used to determine one or more weighted constraints applicable to each factor-quality assessment relationship. The weighted constraints may be based on user input related to expert judgement of the user.

The computing device 102 may include a calibration module 114. In some implementations, the calibration module 114 may be used to calibrate the quality assessment based on at least one of the factor-quality assessment relationships and/or the weighted constraints. In some instances, the quality assessment may be calibrated based on the weighted constraints related to the expert judgement of the user. In other instances, the quality assessment may be calibrated based on identifying adjustments to the factors and/or applying those adjustments to the factors based on user input. The adjustments to the factors may include one or more additional factors and replacement factors. Further, the calibration module 114 in conjunction with the definition module 110 may be used to define one or more parameters for the factor-quality assessment relationship based on the user input. In this instance, the quality assessment may be further calibrated based on identifying adjustments to the parameters and/or applying those adjustments to the parameters associated with one or more of the factor-quality assessment relationship and the weighted constraints. As such, calibration may refer to the process and tools by which a user matches results to expert judgment.

The calibration module 114 may also be used to apply the calibrated quality assessment to one or more other events. For instance, the one or more other events may have a similar nature associated with the event (i.e., initial or original event). These and various other features are described in greater detail herein below.

In various other implementations, the assessment module 112 or the calibration module 114 may be used to translate the factor-quality assessment relationships into a quality assessment value, and as such, the quality assessment may be further calibrated based on the quality assessment value. In some instances, translating the factor-quality assessment relationships may include defining a common curve based on user input by translating the characterized factor-quality assessment relationships into a common unit of measure. The common curve may include a first formula that translates the factors into a consistent value for assessment. Further, in some other instances, translating the factor-quality assessment relationships may include defining a quality curve by translating the sum-product of the common curve for each factor-quality assessment relationship into the quality assessment value. The quality curve may include a second formula that aggregates sum-product translation results to provide a final assessment value. These and various other features are described in greater detail herein below.

In reference to FIG. 1, the apparatus 100 is illustrated using various functional blocks or modules that represent discrete functionality. However, it should be understood that such illustration is provided for clarity and convenience, and therefore, it should be appreciated that the various functionalities may overlap or be combined within a described block(s) or module(s), and/or may be implemented by one or more additional block(s) or module(s) that are not specifically illustrated in FIG. 1. Further, it should be understood that various standard and/or conventional functionality that may be useful to the apparatus 100 of FIG. 1 may be included as well even though such standard and/or conventional elements are not illustrated explicitly, for the sake of clarity and convenience.

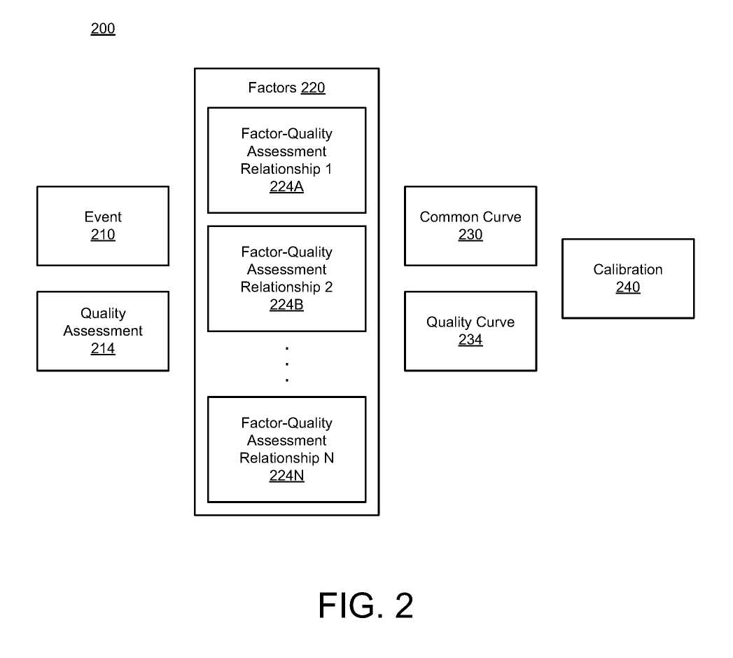

FIG. 2 illustrates a diagram 200 of components utilized for assessing quality of events in accordance with various implementations described herein.

In various implementations, the methods and techniques described herein may utilize various expressions of the components in many forms of computer based media, from spreadsheets to cloud-based solutions, with interfaces ranging from smartphones, tablets, and personal computers. As described herein, the methods and techniques use various components for assessing quality of events. For instance, as shown in FIG. 2, the components may include one or more events 210, one or more quality assessments 214, and one or more factors 220 for assessing quality of events. In some scenarios, the events 210 may be defined based on user input, the quality assessments 214 may be defined for the events 210 based on user input, and the factors 220 for the events 210 may be defined in association with the quality assessments 214. The components may also include a number of factor-quality assessment relationships 224A, 224B, . . . , 224N between each factor 220 and the quality assessments 214 that may be characterized and translated into a quality assessment value. The factor-quality assessment relationships 224A, 224B, . . . , 224N may include defining one or more common curves 230 based on the user input by translating the characterized factor-quality assessment relationships into a common unit of measure. The factor-quality assessment relationships 224A, 224B, . . . , 224N may also include defining one or more quality curves 234 by translating the sum-product of the common curves 230 for each factor-quality assessment relationship 224A, 224B, . . . , 224N into a quality assessment value.

In some other scenarios, the components may include one or more calibrations 240 of the quality assessments based on at least one of the factor-quality assessment relationships 224A, 224B, . . . , 224N and weighted constraints. The weighted constraints may be based on user input related to expert judgement of the user, and the calibrations 240 of the quality assessment may be based on the weighted constraints as related to the expert judgement of the user. Further, the calibrations 240 of the quality assessments may be based on identifying adjustments to the factors 220 and/or applying those adjustments to the factors based on user input. The adjustments to the factors 220 may include one or more additional factors and/or one or more replacement factors. These and various other features related to the methods and techniques for performing calibrations 240 are described herein below.

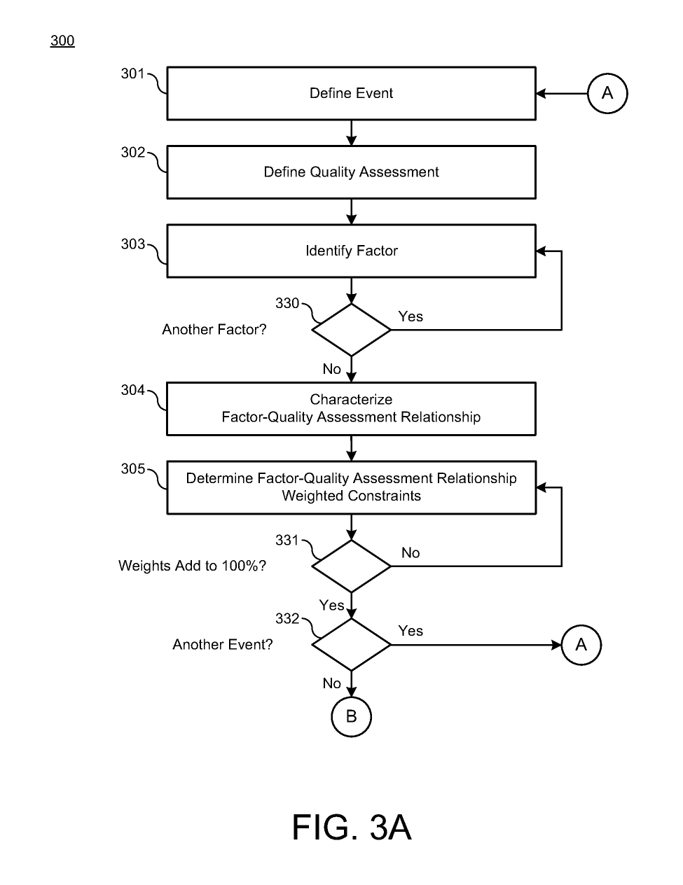

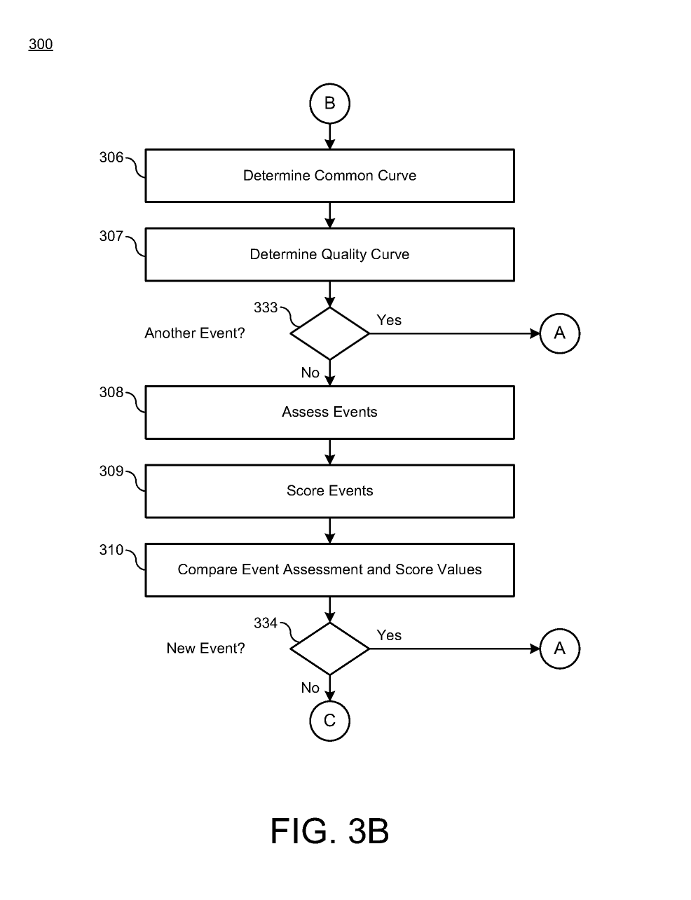

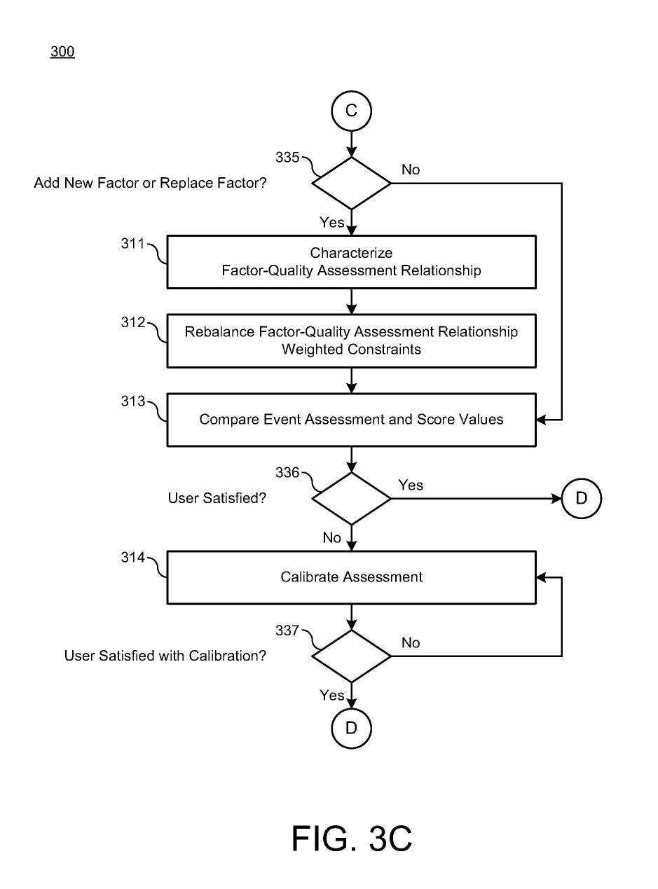

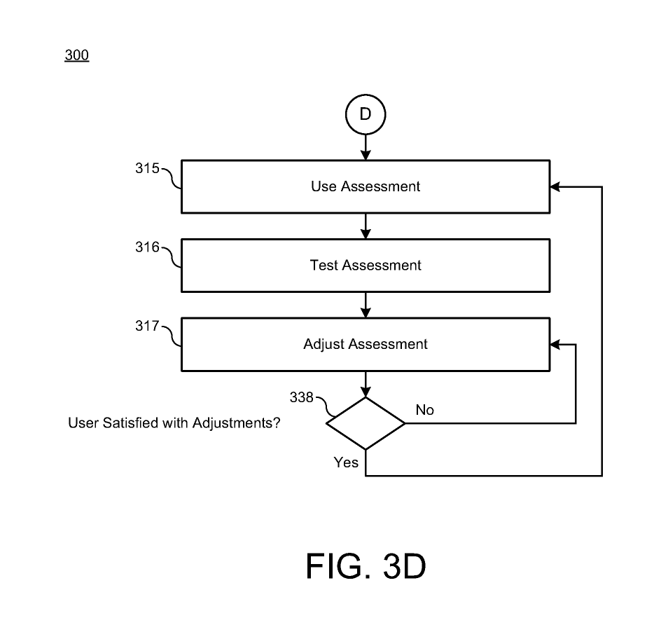

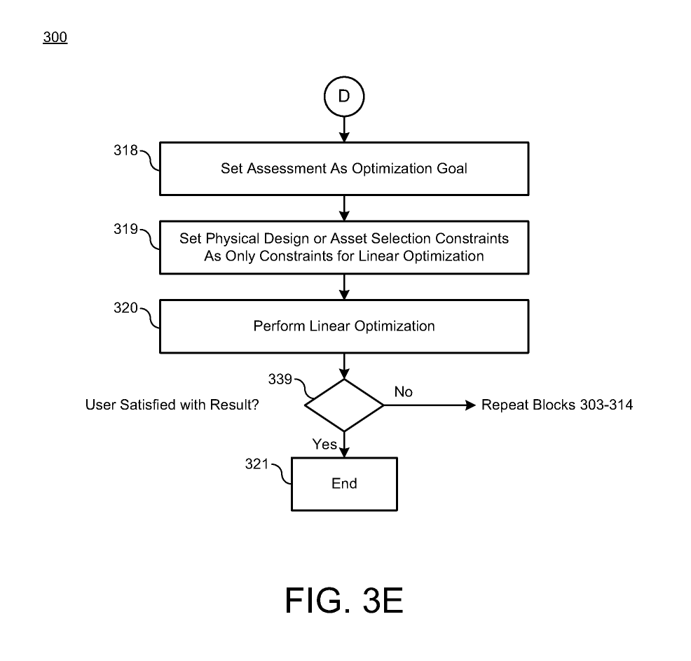

FIGS. 3A-3E illustrate process flow diagrams of methods for assessing quality of events in accordance with various implementations described herein.

In various implementations, the methods and techniques described herein allow a user to define an event for a particular quality assessment and systematically assess that quality for events of a similar nature. The methods and techniques described herein allow the user to define factors for quality assessment and translate those factors into a single quality assessment value. Further, the methods and techniques described herein provide for calibration of the assessments based on the expert judgment of the user. After calibration, the user may apply the assessment to a substantial number of events, and/or the user may utilize the quality assessment as a goal for a design plan or portfolio and increase or optimize its value subject to physical constraints for a solution.

It should be understood that even though the methods of FIGS. 3A-3E may indicate a particular order of operation execution, in various instances, certain portions of operations may be executed in a different order, and on different systems. In some other instances, one or more additional operations may be added to and/or omitted from the methods of FIGS. 3A-3E. Further, the methods of FIGS. 3A-3E may be implemented in hardware and/or software. If implemented in hardware, a computer or various other types of computing devices having a processor and memory may be configured to perform the methods of FIGS. 3A-3E, e.g., such as described herein in reference to FIG. 1. If implemented in software, the methods of FIGS. 3A-3E may be implemented as one or more programs and/or software instruction processes configured to provide for assessing quality of one or more events. Further, if implemented in software, the various instructions related to implementing the methods of FIGS. 3A-3E may be stored and/or recorded in memory and/or a database.

In reference to FIG. 3A, method 300 may perform various tasks associated with assessing quality of one or more events. To illustrate various tasks, some examples are provided. In one example, a safety example, a user may be interested in assessing severity potential of incidents involving dropped objects. In another example, a financial example, a user may be interested in assessing desirability of a portfolio. For instance, in block 301, method 300 may define one or more events. An event may be defined as an occurrence for which a user wishes to assess a specific quality. In the safety example, the safety event may be a dropped object. In the financial example, the event may be the portfolio. In some scenarios, a user may identify the one or more events for a particular quality assessment. The one or more events may include a health, a safety, or an environmental event, or a specific plan design or portfolio. In the safety example, having carried out tasks for quality assessment for a dropped object, the user may add other health, safety, or environmental events, such as, e.g., an event of a fall from heights, or chemical release. For financial applications, specific plan design or portfolio, the events may include exploration target, project, next year's business plan, or strategic portfolio. In the financial example, the user may assess different portfolios for different divisions of an enterprise that have differences, which may warrant different factors for assessing a portfolio.

In block 302, method 300 may define a quality assessment. Quality assessment may be defined as a specific attribute or condition related to the event. In the safety example, the event may be a safety event, and the quality assessment may be designated with severity potential. For a design or portfolio event, the quality assessment may be designated as desirable, optimal, ideal, and/or high performing. In the financial example, the user may select desirable.

In block 303, method 300 may define or identify one or more factors. A factor may include observable data that informs the quality assessment for the event. The user may identify the one or more factors used to inform the quality assessment for the event. In the safety example, one of the factors may include a height from which an object fell for a safety event involving a dropped object. In the financial example, the user may refer to a level of capital to spend in a given a year.

In decision block 330, method 300 may determine whether the user wants to include an additional factor. If yes, then method 300 may repeat block 303 a number of times until the user identifies each factor for the quality assessment. Otherwise, if no, then method 300 proceeds to block 304.

In block 304, method 300 may characterize or determine one or more factor-quality assessment relationships. A factor-quality assessment relationship may be defined as a relationship between the factor and the quality assessment that may be defined by a variety of equations. Characterizing a factor-quality assessment relationship may include the process by which a user, using expert judgment, experience, and statistics, when available, relate measurements of the factor to the quality to be assessed for the event. A standard range of value is from 0 (zero) to 1.0 (one) for the quality assessment values. In some scenarios, the user may characterize one or more factor-quality assessment relationships between each identified factor and the quality assessment. For instance, method 300 allows for a substantial number of means by which to relate the one or more factors to the quality assessment. In the safety example, increasing the height from which an object was dropped may result in increasing the quality assessment of severity potential for the safety event of a dropped object. The user may select an increasing sigmoidal function for the height from which the object was dropped and the quality assessment of severity potential. For heights less than 2 meters, e.g., the user may specify values close to 0 (zero), while heights above 15 meters the user may specify values close to or equal to 1.0 (one). For heights between 2 meters and 15 meters, the user may select values between 0 (zero) and 1.0 (one) for increasing levels of height. For portfolio selection in the financial example, increasing levels of capital spend may result in decreasing the quality assessment for a desirable portfolio. The user may specify that spending below a certain target results in quality assessment values of close to or equal to 1.0 (one), whereas spending above a certain target results in a quality assessment value of close to or equal to 0 (zero). Thus, method 300 may provide for various equations that may be used to model exactly or approximately a substantial number of factor-assessment relationships. In some scenarios, the user may use any equation to shape the factor-quality assessment relationship.

In block 305, method 300 may determine weighted constraints for the factor-quality assessment relationships. A weighted constraint may be defined as a percentage, between 0% and 100% that the user wants to apply to each factor-quality assessment relationship curve in determination of the quality assessment for the event. In the safety example, if there are multiple factors informing a severity potential quality assessment, the user may weight all factors equally. Conversely, a user may want to assign more weight on a particular factor. In the financial example, the user may be more concerned with capital spend, and therefore, the user may put a higher weight to the capital spend factor-quality assessment relationship relative to other factors used for assessing the portfolio's quality of ideal.

In decision block 331, method 300 may determine whether the weighted constraints add up to 100%. If no, then method 300 may repeat block 305 a number of times until the weighted constraints sum to 100%. In the financial example, the user may notice that the sum of weighted constraints for portfolio factor-quality assessment relationships sum to 120%. Accordingly, the user may repeat step 305 until the sum of weights is 100%. Otherwise, if yes, then method 300 proceeds to block 332. In the safety example, the user may have designated weighted constraints that sum to 100%, and as such, method 300 may proceed directly to block 332.

In decision block 332, method 300 may determine whether the user wants to add another event to the quality assessment. In the safety example, the user may want to add the event of fall from heights or motor vehicle accident. In the financial example, the user may want to add another portfolio for another division of an enterprise. If yes, then method 300 returns to block 301 to define another event. If no, then method 300 proceeds to block 306.

In reference to FIG. 3B, method 300 may perform various tasks associated with assessing quality of one or more events. In block 306, method 300 may determine a common curve. The common curve may be defined as a function that translates the output from each individual factor-quality assessment relationship into a common unit of measure across all the factor-quality assessment relationships. In some cases, method 300 may use a logistic curve with a range of 0 (zero) to 100, an upper boundary height of 1, a sigmoidal mid-point of 50, and a steepness of 0.1 (zero point one). In the safety and financial examples, the user may choose to use these parameters for the common curve. For example, in the safety event of dropped object, an event involving a fall from height of 10 meters with a factor-quality assessment value of 0.8 (zero point eight). The common curve may translate this into a value between 0 (zero) and 100, and in the present case a value of 60. However, the user may use any parameters for the logistic curve. Alternatively, the user may use any function from block 304 to shape the common curve.

In block 307, method 300 may determine a quality curve. The quality curve may be defined as a function that translates the sum-product of the common curve results for each factor into a quality assessment value. In some cases, method 300 may use a logistic curve with a range of 0 (zero) to 100, an upper boundary height of 1 (one), a sigmoidal mid-point of 50, and a steepness of 0.1 (zero point one). In the safety and financial examples, the user may choose to use these parameters for the quality curve. The quality curve may translate a sum-product of the common curve results as inputs on a scale of 0 (zero) to 100, and may translate this into a quality assessment value of between 0 (zero) and 1 (one) multiplied by 100. In the safety example of a dropped object, a sum-product may result from a height from which the object was dropped along with other factors may be 52. The quality curve may translate this value into 55, which is the result of 0.55 (zero point fifty five) multiplied by 100. However, the user may use any parameters for the logistic curve. Alternatively, the user may use any function from block 304 to shape the quality curve.

In various implementations, the methods and techniques described herein allow for many different types of curve to be used, not limiting the factor-quality assessment relationships to those that are monotonically increasing or decreasing. This may provide ability for the user to use triangular curves, trapezoidal curves, normal curves, bell curves, and inverses of curves to model the relationship between data inputs and event characteristics.

In decision block 333, method 300 may determine whether the user wants to add another event to the quality assessment. If yes, then method 300 returns to block 301 to define another event. If no, then method 300 proceeds to block 308.

In block 308, method 300 may assess the one or more events. In some scenarios, the user may utilize method 300 to determine the quality assessment of either known events or randomly generated events. In the safety example for the event dropped object, the user may either pull known events of dropped objects and using the available data related to the factors for assessing the severity potential for dropped objects to assess the severity potential of the known events. Alternatively, the user may generate random cases of dropped object events with various data related to the factors for assessing the severity potential for dropped objects to assess the severity potential of random cases of dropped object events. In the financial example for a portfolio, the user may sample known potential portfolios that may be selected, and using the available data related to the factors for assessing the quality of ideal for portfolios to assess the quality of ideal for the sample portfolios. Alternatively, the user may generate random hypothetical portfolios that may be selected, and the user may use the data related to the factors for assessing quality of ideal to assess the quality of ideal for the hypothetical portfolios.

In block 309, method 300 may score the one or more events. In some scenarios, the user may ask clients for quality assessments of similar known events or randomly generated events utilized in block 308. In the safety example for the event of dropped object, the user may give clients either the known or randomly generated cases for dropped objects and ask the clients to score the severity potential of the events on the same scale as the quality assessment value for dropped objects. In the financial example, the user may give clients either known potential portfolios or random hypothetically portfolios that may be selected, and the user may ask the clients to score the quality of ideal of the portfolio events on the same scale as the quality assessment value for portfolios.

In block 310, method 300 may compare the event assessment and the score values. In some scenarios, the user may compare the assessments by method 300 with those of the clients. In the safety example, the user may compare the severity potential assessed with the severity potential scores for the dropped object cases to determine where material differences, if any. In the financial example, the user may compare the quality of ideal assessed with the quality of ideal scores for the portfolios to determine where material difference, if any.

In decision block 334, method 300 may determine that a subset of events may belong to a new event type. If yes, then method 300 may return to block 301 to define this new event type. In the safety example, the user may decide that dropped object events may be split between hand tools or smaller objects held by a worker from larger objects that were dropped due to a failure of lifting equipment. In the financial example, the user may decide that separate portfolio types may be needed, one for highly uncertain research and development opportunities that is separate from known development opportunities that carry relatively less risk. Otherwise, if no, then method 300 proceeds to decision block 335 for remaining event types.

In reference to FIG. 3C, method 300 may perform various tasks associated with assessing quality of one or more events. For instance, in decision block 335, method 300 determines whether a new factor is requested (or needed) for the remaining event types, or whether a replacement of an existing factor is requested (or needed) for the remaining event types. In the safety example, the user and clients may determine that an additional factor, such as a number of people that may be potentially affected, may be added to the list of factors. In the financial example, the user and clients may determine that five-year cumulative average growth rate of production may be added as a factor. If no, then method 300 proceeds to block 313. Otherwise, if yes, then method 300 proceeds to block 311.

In block 311, method 300 may characterize or determine one or more factor quality relationships. In some scenarios, block 311 may be performed in a manner similar to performing block 304 for each new additional or replacement factors.

In block 312, method 300 may rebalance weighted constraints for one or more factor-quality assessment relationships. In some scenarios, block 312 may be performed in a manner similar to performing block 305 for each new additional or replacement factors. As such, method 300 may assure that the sum of the weighted constraints is 100%.

In block 313, method 300 may compare event assessments and score values. In some scenarios, with one or more new factor(s) defined, method 300 may compare the assessments with those of the clients. In the safety example, the user and clients may note differences is the assessed value and scores for the dropped objects where the object mass is greater than a certain level of mass, with the assessment generating consistently lower assessments than the client scores for severity potential. In the financial example, the user and clients may note that portfolios that exceed a particular level of capital spend the assessments are consistently higher than the client scores for the quality of ideal.

In decision block 336, method 300 determines whether the user is satisfied with the assessment. If yes, then method 300 proceeds to block 315. In the safety example, the user and clients may determine that the assessed value is correct and that no adjustments to factors, factor-quality assessment relationships or weighted constraints may be needed. Otherwise, if no, then method 300 proceeds to block 314. In the financial example, the user and clients may determine that adjustments may be needed because capital spend is more important than previously determined and a calibration to match client scores may be needed. As such, the clients may decide to lower an amount of capital that may be considered ideal and as well as lower an amount of capital that may be considered not ideal.

In block 314, method 300 may calibrate the assessment. In some scenarios, analysis by the user may identify where adjustments can be performed (e.g., identified and/or applied) to the input factors or if additional or replacement factors are requested (or needed). In some cases, a variety of techniques may be employed to adjust parameters of the factor-quality assessment relationships and/or the weighted constraints associated with the factor-quality assessment relationships. This may include minimization of the sum of the square of difference between an event model and event score values. In the financial example, where the clients determined that capital spend was more important than previously determined, the clients decided to increase the weighted constraint for capital spend and reduce the weighted constraints for the other factors.

In some implementations, the methods and techniques described herein allow a user to shape relationships between factors and the characteristics or attributes the user is seeking to assess. These relationships may be shaped based on expert judgement of the user. The methods and techniques described herein may allow the user to establish reasoned relationships between input data and characteristics of the event for which the user is performing the assessment. In the financial example, for instance, in addition to modifying the weighted constraints, the clients may also change the shape of the factor-quality assessment curve for capital spend by producing a lower score for lower levels of capital spend.

In some implementations, the methods and techniques described herein may provide for a means by which the user may test the results of the model generated by the assessment and compare the results to expert judgment of the user. This allows the user to have assurance that the model assessment may be calibrated to their expert judgment before deploying at scale in their organization. In some cases, this may enable the user to overcome challenges of limited, heterogeneous events and limited data quantity and quality and use for more assessment needs. As such, the methods and techniques described herein may provide for an explicit means by which to review assessment results and then test the veracity of the model on a periodic basis. This may enable the user to improve the model when events and data are relatively scarce.

In decision block 337, method 300 determines whether the user is satisfied with the calibration results. If no, then method 300 may return to block 314 to repeat the calibration. Otherwise, if yes, then method 300 may thus proceed to block 315. In some scenarios, if the user is satisfied with the results, the calibrated events provide for a model that may become the quality assessment for other similar events. In reference to a design plan or portfolio, the model may be used as an object for optimization subject to physical constraints of a design or portfolio selection.

In some implementations, method 300 of FIG. 3C may proceed to method 300 of FIG. 3D. In reference to FIG. 3D, method 300 may perform various tasks associated with assessing quality of one or more events. For instance, in block 315, method 300 may apply the model of assessments to the events that have been defined for the model using data identified for the factors for each quality assessment.

In block 316, method 300 may collect data and perform random investigations to test the model assessments and periodically adjust input factors to remove occurrences of false positives and false negatives. In the safety example, the user may collect assessments of dropped objects. In some cases, the clients may note that the assessment for some events, in their professional judgement, was either low or high and flag for follow up. Additionally, when cases have a high severity potential assessment and a full investigation may be conducted, the investigation results may suggest that the severity potential was low. Further, the user may randomly select several dropped object events where the severity potential assessment was low, but conduct a full investigation to confirm. In block 317, method 300 may use results from the one or more events and random investigations to adjust the factor set, either adding new factors, substituting factors, or shaping the factor-quality assessment relationships for the existing factors. In the safety example, from the various sources of flagged events, results of full investigations of high severity assessed events, and results from random full investigations of low severity assessment events, the user and clients may determine if actual severity potential of events match the severity potential assessments. While not part of the ideal model assessments, the common curve and the quality curve may also be updated or revised. The user may also select to add or remove events for assessments conducted by the model assessments.

In some implementations, the methods and techniques described herein allow the user to utilize calibration to hold to a single common curve and a single quality curve, and allow the user to utilize adjustments to the factor-quality assessment relationships to assure that model results match expectations. While the user is free to create an individual common curve and quality curve for each event, it is not expected. This simplification allows for easier calibration of the model by focusing on the factor-quality assessment relationships while enabling easier scaling of the model to a number of events.

In decision block 338, method 300 determines whether the user is satisfied with the adjustments. If no, then method 300 may return to block 317 to repeat the adjustments. Otherwise, if yes, then method 300 may return to block 315.

In some implementations, method 300 of FIG. 3C may proceed to method 300 of FIG. 3E. In reference to FIG. 3E, method 300 may perform various tasks associated with assessing quality of one or more events. For instance, in block 318, method 300 may set the assessments with various types of optimization goals, such as, e.g., a linear optimization goal, a non-linear goal, etc. In some scenarios, method 300 may define a quality of a plan design or portfolio, using goals and constraints (or tradeoffs) as factors for the quality assessments. As such, method 300 may set the resulting quality assessment as the goal for optimization, such as, e.g., linear optimization.

In block 319, method 300 may set a physical design and/or asset selection constraints as only constraints for linear optimization. For example, the physical parameters for a project may generate a number of results affecting timing, cost, quality, risk and safety. By translating these results into factors for quality assessment, the only constraints for assessing the ideal design is the physical parameters for a project, such as height, weight, footprint, or any other physical parameter in the design of the project. For a financial example, specifically a portfolio, the selection of a variety of projects may be limited by the absolute quantity of projects available, timing constraints for selection or dependencies between projects. Capital spend, production, return, and risk are the result of these quantity and timing choices. By translating the results of capital spend, production, return, and risk into factors for assessing the quality of ideal for the portfolio, the only constraints for assessing the ideal portfolio is the number of projects of timing of project selection. In some scenarios, method 300 may define linear optimization constraints as only those physical constraints which govern the optimization of the quality assessment using linear optimization techniques.

In block 320, method 300 may perform linear optimization. In some scenarios, method 300 may perform linear optimization to optimize the quality assessment value subject to the physical design and/or the asset selection constraints.

In decision block 339, method 300 determines whether the user is satisfied with the result. If no, then method 300 may repeat blocks 303-314. Otherwise, if yes, then method 300 may terminate or end in block 321. As such, in some scenarios, if the user is not satisfied with the results, method 300 may repeat all or part of blocks 303-314. Otherwise, method 300 ends the optimization and applies the model assessments to one or more new events associated with some other quality assessment.

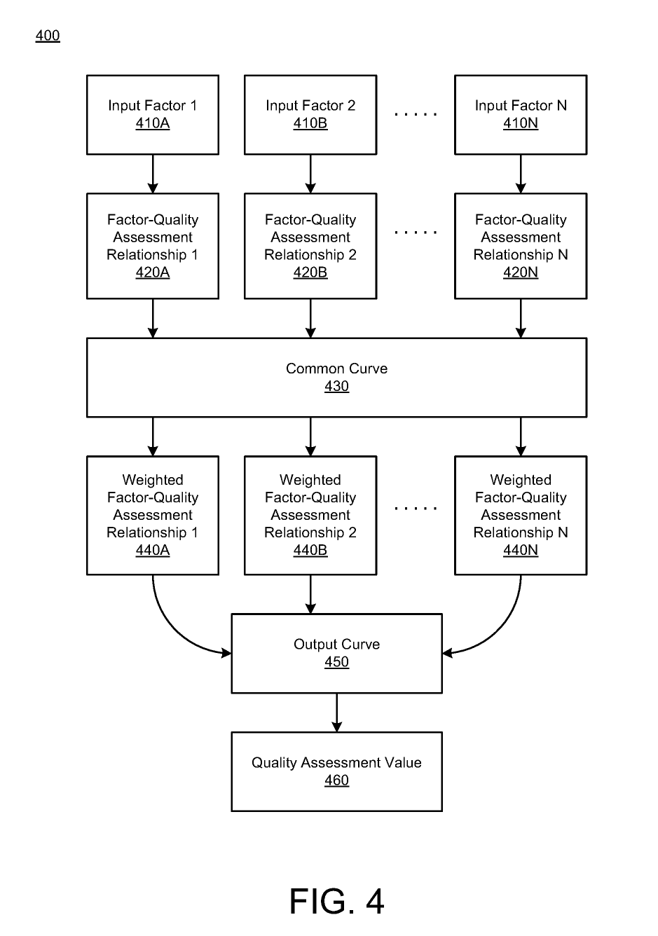

FIG. 4 illustrates a process diagram of a method 400 for calculating a quality assessment value in accordance with various implementations described herein. The quality assessment value may be the measure, e.g., between 0 (zero) and 100, resulting from the quality curve. The quality assessment value is the value association with the quality assessment for the event assessed. In the safety example, the quality assessment value may be a value between 0 (zero) and 100, which measures the severity potential of a dropped object. In the financial example, the quality assessment value may be a value between 0 (zero) and 100, which measures the quality of ideal for the portfolio results from the assets selected.

In various implementations, the method 400 may utilize a calculation technique to provide (or generate) a quality assessment value 460. For instance, in some scenarios, method 400 may receive a number of input data factors 410A, 410B, . . . , 410N. Method 400 may then use the input data factors 410A, 410B, . . . , 410N to calculate (or generate) a number of data factor-quality assessment relationships 420A, 420B, . . . , 420N. Method 400 may then use the data quality relationships 420A, 420B, . . . , 420N to calculate (or generate) a common curve 430. Using data from the common curve 430, method 400 may thus calculate (or generate) a number of weighted data factor-quality assessment relationships 440A, 440B, . . . , 440N. Method 400 may use the weighted data factor-quality assessment relationships 440A, 440B, . . . , 440N to calculate (or generate) an output curve 450. Further, using the output curve 450, method 400 may then calculate (or generate) the quality assessment value 460.

In some implementations, the methods and techniques described herein allows for application to events that are relatively heterogeneous and infrequent in occurrence and where data may not have been collected in a systematic fashion prior to the need to assess the quality of events and situations. This may include assessment of the severity potential of actual severe events and actual minor events. Further, this may allow the user to assess the severity potential for many events, regardless of actual severity, and do so at scale. By extension, a set of factors may be taken for the severity potential of tasks before events commence. As such, industries may be able to use this application, and this application may be particularly valuable for some organizations with a significant number of health, safety, and/or environmental events and/or jobs that may benefit from systematic assessment of their severity potential.

In some implementations, by defining a design plan and/or portfolio quality as desirable or optimal, the user may overcome the inherent limitations of linear optimization in seeking optimal solutions for plan and portfolio development and selection. Further, by removing the linear constraints of the desired features of plans and portfolios, the user may utilize the methods and techniques described herein to improve or optimize the desirability of a plan or portfolio subject only to physical constraints. This may be a new way to design plans and portfolios and assures that the user finds a solution, maintains a consistent trade-off of design needs for a plan or portfolio, avoids risks of asset based performance inflation to make linear optimization techniques capable of finding a mathematical solution, provide a consistent score against which to compare alternatives, and many industries may be able to use this application.

There are several benefits associated with using the methods and techniques described herein when comparison to risk matrices, scorecards, fuzzy scalable monotonic chaining, and predictive analytical approaches. The methods and techniques described herein may expand the range for event type modeling and provide for assessments and predictions when situations or events request assessment that are relatively infrequent or heterogeneous. The methods and techniques described herein may overcome data limitations and may provide assessments and predictions when data is either scare or inconsistent. The methods and techniques described herein may allow expert judgment to develop models that work from factors to data, rather than data to factors. The methods and techniques described herein may provide a greater range of modeling by applying a unique modification to membership functions for versatile and simpler modeling. The methods and techniques described herein may enable a greater number of factors for prediction. Through modifications of the chained monotonic scaling method, the methods and techniques described herein may allow for an easier combination of as many factors a user believes is required for assessment and prediction. The methods and techniques described herein may be transparent and may allow users to define and update variable relationships. The methods and techniques described herein may provide consistency and may enable consistent assessments by rooting factors in scalable input factors and/or by removing human bias through the inconsistency of decision-making. The methods and techniques described herein may provide for calibration and reduced improvement cycle-time to thereby assist the user with calibration of results before a first use, which may greatly reduce the cycle-time for improving the learning by the model. The methods and techniques described herein may provide the user with an ease of use by combining the processes and algorithms together in a comprehensive package, wherein the user may rapidly model and use the techniques regardless of the applications. The methods and techniques described herein may provide solutions for long-standing problems, thereby solving long-standing problems posed by linear optimization for portfolio selection and development plan design. The methods and techniques described herein may also solve problems associated with risk matrices and scorecards for risk assessment to thereby allow for more mathematically sound methods for assessments at scale.

In some implementations, the methods and techniques described herein takes a different approach and uses a unique set of processes and algorithms for situation risk assessment. Instead of using data to find the factors for predictive uses, the user defines and shapes the factors, calibrates the results to their judgments, and then defines data collections to apply and improve the model over time. While the methods and techniques described herein may be used for substantial data sets and homogenous events, they may also handle situations of limited, scarce data availability and relatively infrequent or heterogeneous events. This may be particularly useful for assessments of situations and events that request expert judgment for assessment of meaning.

In some implementations, the methods and techniques described herein may be used for incident severity assessment. For instance, in some scenarios, the user may be able to consistently evaluate the severity potential of events regardless of variations of actual event severity, quantity of events, and/or resources to conduct evaluations. This may enable the user to directly investigate resources for those events which may hold the highest potential for identification of corrective actions so as to reduce the likelihood and severity of catastrophic events. The result may include a drop in actual events of severity levels, as well as, the ability to identify and execute corrective actions informed by minor events and stave-off catastrophic events. The user may be able to accomplish this with a minimization of resources since expert judgment may be used by the model. Further, the methods and techniques described herein may be utilized in scenarios involving pre-job hazard assessment. For instance, this idea may be closely related to incident severity assessment, and as such, the user may use the methods and techniques described herein to enable consistent, at-scale assessments of pre-job hazards. As such, this approach may allow the user to take consistent, targeted interventions before job tasks commence, which may thus reduce the likelihood of events.

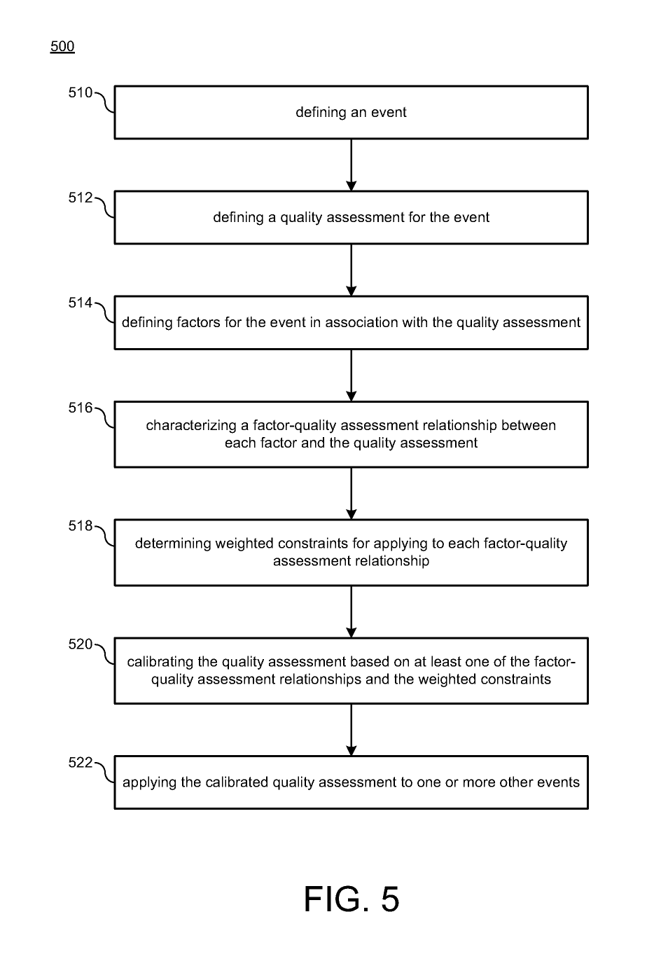

FIGS. 5-7 illustrate process flow diagrams of methods for assessing quality of events in accordance with various implementations described herein.

In particular, FIG. 5 illustrates a process flow of a method 500 for assessing quality of an event in accordance with various implementations described herein.

It should be understood that even though method 500 may indicate a particular order of operation execution, in some instances, various certain portions of the operations may be executed in a different order, and on different systems. In some other instances, additional operations or steps may be added to and/or omitted from method 500. Further, the method 500 may be implemented in hardware and/or software. If implemented in hardware, a computer or various other types of computing devices having a processor and memory may be configured to perform method 500, e.g., such as described herein in reference to FIG. 1. If implemented in software, the method 500 may be implemented as a program and/or a software instruction process that may be configured to provide for assessing quality of one or more events. Further, if implemented in software, instructions related to implementing the method 500 may be stored in memory and/or a database.

In reference to FIG. 5, method 500 may provide for assessing quality of one or more events. For instance, at block 510, method 500 may define an event, and at block 512, method 500 may define a quality assessment for the event. In the safety example, the user may define an event as a dropped object, and the user may define the quality assessment as severity potential. Other examples of events may include fall from heights, motor vehicle accidents, struck by events, chemical releases, loss of containment resulting in chemical releases and/or explosions and/or fires. In these events, the quality assessment may be severity potential; however, other qualities may be assessed as defined by the user, such as, e.g., actual severity. Other examples may include pre-job hazard assessments, where the event may include a particular task to be performed by a team, such as, e.g., a maintenance or installation task, and the quality to be assessed may include hazard potential. Further, at block 514, method 500 may define one or more factors for the event in association with the quality assessment. In some implementations, the event includes at least one of a health event, a safety event, a security event, and an environmental event. Further, defining the event may be based on user input, and defining the quality assessment for the event may be based on the user input. The event may include one or more events for which a user or other operator seeks to make the quality assessment, and further, the quality assessment may include at least one of a characteristic, an attribute, and a quality of the event for the quality assessment. In the safety example, for an event of dropped object, the user may define the factors as mass of object dropped, height from which the object was dropped, the number of people that may have been potentially impacted by the event, the use of proper controls for the tasks performed when the incident occurred, and the time for emergency response. However, factors may be different for other events. For a motor vehicle accident, while use of proper controls, the number of people potentially impacted by the event and time for emergency response may remain as factors, and factors unique to the motor vehicle accident may be applied to determine the maximum amount of force to which a single person was exposed in the event. Such factors for force determination may include the speed of the motor vehicles involved, the use of seatbelts, and type of accident such as a head on collision, overtake, rollover or striking a fixed object. In the dropped object and the motor vehicle accident event, the quality assessment may be severity potential. In the pre-job hazard example, the factors may include factors related to the complexity of the task, the conditions under which the task is performed, and the skill level of those performing the task.

At block 516, method 500 may characterize a factor-quality assessment relationship between each factor and the quality assessment, and at block 518, method 500 may determine weighted constraints for applying to each factor-quality assessment relationship. In some implementations, the weighted constraints may be based on user input related to expert judgement of the user. In the safety example for a dropped object, the user may specify a factor-quality assessment relationship for mass of an object that is a sigmoidal function with increasing mass causing an increase in severity potential. The sigmoidal function may be chosen to reflect the user's judgment that the severity potential is assumed to be relatively low for all masses below a certain level and that the severity potential is assumed to be relatively high for all masses above a certain level, with a sigmoidal transition between those minimum and maximum mass levels. Alternatively, the user may use a linear function, where increases in mass always produce an increase in severity potential. For another factor chosen for a dropped object event, such as the proper use of controls, increases in measures related to proper control use may decrease severity potential. Again, the user may select a sigmoidal function, but with parameters reflecting higher measurements of proper use of controls leading to lower severity potential. The factor-quality assessment relationships for mass of object and proper use of control relate to the same quality assessment, severity potential, but with different functions reflecting the expert judgment of the user regarding the relationship of the factor to severity potential. Having selected mass and proper use of controls as factors, the user may assign a weighted constraint to each factor-quality assessment. The user may choose to apply equal weighted constraints to each factor, in this case 50% for each. However, the user may place more emphasis on the mass of the object and apply 70% to the mass-severity potential relationship and 30% to the proper use of controls-severity potential relationship. In the pre-job hazard example, the factor-quality assessment relationships may relate those measured factors for complexity of task, conditions under which the task is to be performed, and the skill level of those to perform the specific task to the quality of hazard potential. The user may assign weighted constraints based on their judgment on which factors have higher or lower bearing on the assessment of the quality of hazard potential.

At block 520, method 500 may calibrate the quality assessment based on at least one of the factor-quality assessment relationships and the weighted constraints, and at block 522, method 500 may apply the calibrated quality assessment to one or more other events, which may have a similar nature associated with the event. In some cases, calibrating the quality assessment may be based on the weighted constraints related to the expert judgement of the user. In some other cases, calibrating the quality assessment may be based on identifying adjustments to the factors and/or applying those adjustments to the factors based on user input. The adjustments to the factors may include one or more additional factors and replacement factors. Further, method 500 may define parameters for the factor-quality assessment relationship based on the user input. In this case, calibrating the quality assessment may be further based on identifying adjustments to the parameters and/or applying those adjustments to the parameters associated with the factor-quality assessment relationships and/or the weighted constraints.

In some implementations, method 500 may further translate the factor-quality assessment relationships into a quality assessment value, and method 500 may further calibrate the quality assessment based on the quality assessment value. In some cases, translating the factor-quality assessment relationships may include defining a common curve based on user input by translating the characterized factor-quality assessment relationships into a common unit of measure. The common curve may include a first formula that translates the factors into a consistent value for assessment. In some other cases, translating the factor-quality assessment relationships may include defining a quality curve by translating the sum-product of the common curve for each factor-quality assessment relationship into the quality assessment value. The quality curve may include a second formula that aggregates sum-product translation results to provide a final assessment value.

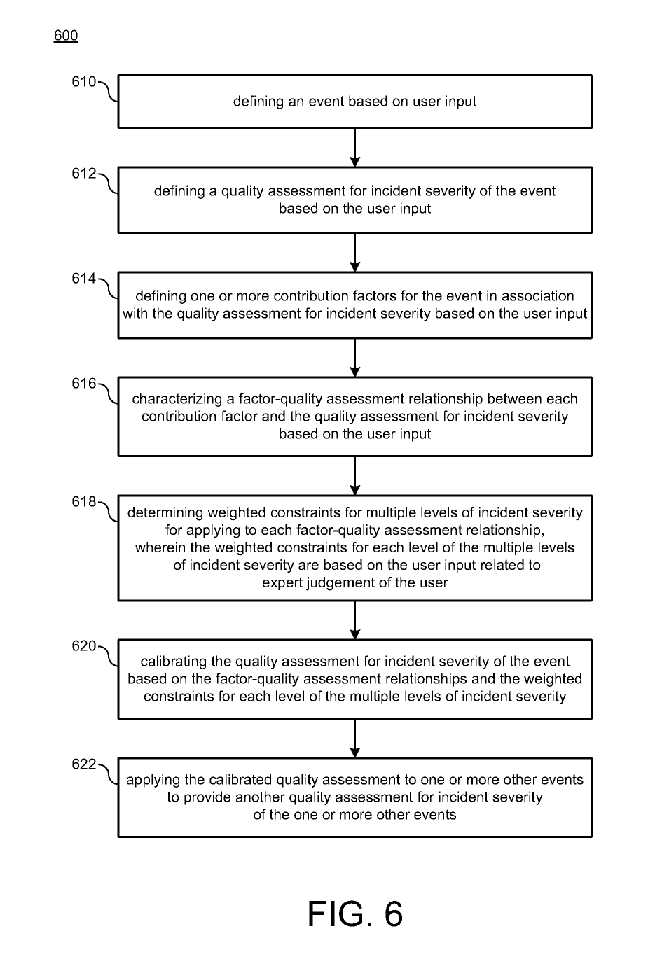

FIG. 6 illustrates another process flow of a method 600 for assessing quality of incident severity for an event in accordance with various implementations described herein. For instance, in some scenarios, the quality assessment may be associated with incident severity of the event.

It should be understood that even though method 600 may indicate a particular order of operation execution, in some instances, various certain portions of the operations may be executed in a different order, and on different systems. In some other instances, additional operations or steps may be added to and/or omitted from method 600. Further, the method 600 may be implemented in hardware and/or software. If implemented in hardware, a computer or various other types of computing devices having a processor and memory may be configured to perform method 600, e.g., such as described herein in reference to FIG. 1. If implemented in software, the method 600 may be implemented as a program and/or a software instruction process that may be configured to provide for assessing quality of one or more events. Further, if implemented in software, instructions related to implementing the method 600 may be stored in memory and/or a database.

In reference to FIG. 6, method 600 may provide for assessing quality of one or more events. For instance, at block 610, method 600 may define an event based on user input, and at block 612 method 600 may define a quality assessment for incident severity of the event based on the user input. Further, at block 614, method may define one or more contribution factors for the event in association with the quality assessment for incident severity based on the user input. The event may include a health event, a safety event, a security event, and/or an environmental event. As an example of a chemical release, the user may select a general release of chemicals incident. The quality to be assessed in the incident severity to determine if the incident was a low severity incident or high severity incident. The user may select a number of factors for the assessment. The factors may include among others, the number of people that may have been affected by the chemical release, the degree to which proper controls were used when the task occurred, the reoccurrence of similar events related to chemical releases, the time for emergency response, the duration of the release, and the hazard level of the chemical released.

At block 616, method 600 may characterize a factor-quality assessment relationship between each contribution factor and the quality assessment for incident severity based on the user input. At block 618, method 600 may determine weighted constraints for multiple levels of incident severity for applying to each factor-quality assessment relationship. In some cases, the weighted constraints for each level of the multiple levels of incident severity may be based on the user input related to expert judgement of the user. In the example of a chemical release incident, the user may characterize the number of people potentially affected to severity as increasing sigmoidal function, with 2 or less people impacted as relatively low severity and 5 or greater as a very high level of severity and a sigmoidal curve between 2 and 5 that is increasing. For the proper use of controls the user may select a decreasing sigmoidal curve, with increasing measurement of proper use of controls indicating lower level of incident severity. For the factor of reoccurrence, the user may characterize the factor-quality assessment relationship as an increasing sigmoidal curve with higher levels of site specific reoccurrence as an indication of higher incident severity. For the factor of time for emergency response, the user may use an increasing sigmoidal curve to indicate that higher levels of time for emergency response increase severity. For the factor of duration of the chemical release, the user may select an increasing sigmoidal curve to indicate that higher duration leads to increasing severity. Further, for a factor of hazard level of chemical, the user may use an increasing sigmoidal curve to characterize the factor-quality assessment relationship as one where increasing hazard levels of the chemical lead to higher incident severity. The user may then assign equal weighted constraints to each factor. Alternatively, the user may determine that the hazard level for the chemical should receive a higher weighted constraint, for example 30%. The user may determine that duration is should also receive 30%, with the remaining four factors each receiving 10%.

At block 620, method 600 may calibrate the quality assessment for incident severity of the event based on the factor-quality assessment relationships and/or the weighted constraints for each level of the multiple levels of incident severity. At block 622, method 600 may apply the calibrated quality assessment to one or more other events to provide another quality assessment for incident severity of the one or more other events. In various cases, the one or more other events may have a similar nature associated with the event (i.e., initial or original event). In the chemical release example, the user may take either known incidents or randomly generated incidents of chemical releases and assess them while simultaneously requesting scoring by clients for the same incidents. Analysis of the assessments and the scores may lead to adjustments to either the factors utilized for assessment, changes to the characterization of the factor-quality assessment relationships or the changes to the weighted constraints until the user and clients are satisfied that assessments match their expert judgment for incident severity for the incidents under consideration. After calibrating the quality assessment, the user and clients may use the quality assessment to assess the severity potential of chemical release incidents as they occur.

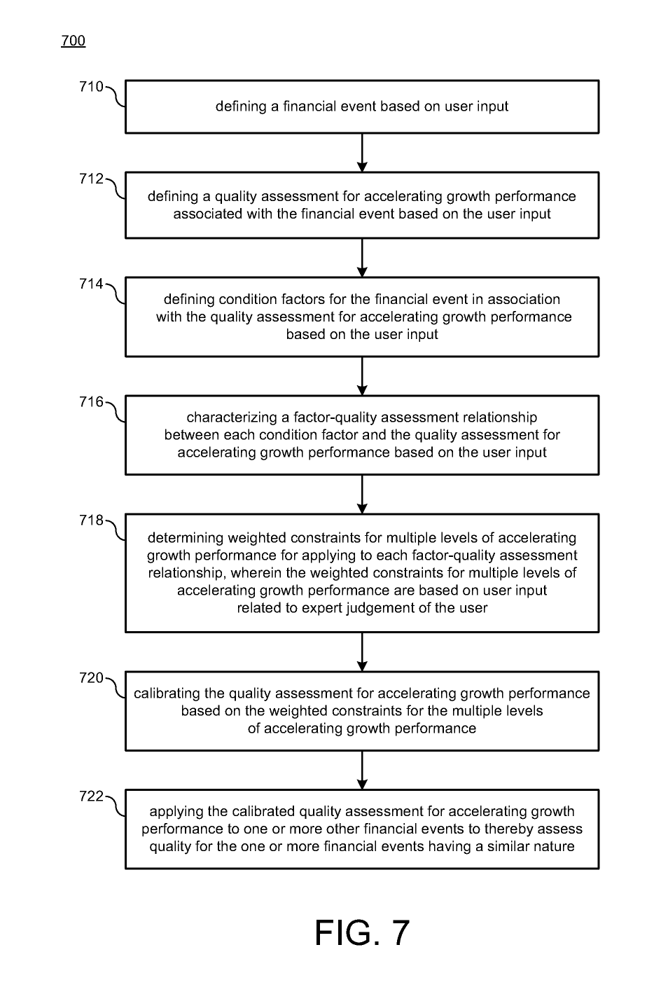

FIG. 7 illustrates another process flow of a method 700 for assessing quality of a financial event in accordance with various implementations described herein. For instance, in some scenarios, the quality assessment may be associated with accelerating growth performance of the financial event.

It should be understood that even though method 700 may indicate a particular order of operation execution, in some instances, various certain portions of the operations may be executed in a different order, and on different systems. In some other instances, additional operations or steps may be added to and/or omitted from method 700. Further, the method 700 may be implemented in hardware and/or software. If implemented in hardware, a computer or various other types of computing devices having a processor and memory may be configured to perform method 700, e.g., such as described herein in reference to FIG. 1. If implemented in software, the method 700 may be implemented as a program and/or a software instruction process that may be configured to provide for assessing quality of one or more events. Further, if implemented in software, instructions related to implementing the method 700 may be stored in memory and/or a database.

In reference to FIG. 7, method 700 may provide for assessing quality of one or more financial events. For instance, at block 710, method 700 may define a financial event based on user input, e.g., a strategic sales plan, and at block 712, method 700 may define a quality assessment for accelerating growth performance associated with the financial event based on the user input. In this example, this may be accelerating growth performance associated with a strategic sales plan. Further, at block 714, method 700 may define condition factors for the financial event in association with the quality assessment for accelerating growth performance based on the user input. For example, a user and clients may have several factors that relate to the quality of accelerating growth performance for a strategic sales plan. Factors may include total profit from new customers over a particular time period, the number of new customers over a particular time period, the diversity of products sold to the new customers over a particular time period, the number of new customers by the next fiscal year, the cost of customer acquisition, and the profit margin for customer sales. In various cases, the financial event may include one or more financial events for which a user seeks to make the quality assessment, and the quality assessment may include at least one of a characteristic, an attribute, and a quality of the event for quality assessment.

At block 716, method 700 may characterize a factor-quality assessment relationship between each condition factor and the quality assessment for accelerating growth performance based on the user input. In the example of assessing the quality of accelerating growth performance for a strategic sales plan, several factors were identified. The user and clients may choose to characterize the factor-quality assessment relationship for the total profit from the new customers over a particular time period as an increasing sigmoidal function with increasing total profit from new customers resulting in an increasing assessment of accelerating growth performance. The user and clients, similarly, may use an increasing sigmoidal function for the number of new customers over a particular time period, the diversity of products sold to the new customers over a particular time period, the number of new customers by the next fiscal year, and the profit margin for customer sales. Conversely, the user and clients may choose to characterize the factor-quality assessment relationship for the cost of customer acquisition as a decreasing sigmoidal function with increases in average acquisition cost per customer with a decreasing assessment of accelerating growth performance. At block 718, method 700 may determine weighted constraints for multiple levels of accelerating growth performance for applying to each factor-quality assessment relationship. In some cases, the weighted constraints for multiple levels of accelerating growth performance may be based on user input related to expert judgement of the user. Continuing with the above example, the user and clients may choose to apply equal weighted constraints to each factor-quality assessment relationship. Alternatively, the user and clients may choose to apply a higher weighted constraint to the total profit from new customers over a particular time period, for example 40%. The user and clients then may apply 15% to both the number of new customers by the next fiscal year and the cost of customer acquisition, and dividing the remaining 30% for the other three factors at 10% each.

At block 720, method 700 may calibrate the quality assessment for accelerating growth performance based on the weighted constraints for the multiple levels of accelerating growth performance. For example, the user may generate random strategic sales plan and assess them and ask clients to score them. Analysis of the assessments and scores for these random strategic sales plan may lead to the addition of factors, re-characterization of one or more of the factor-quality assessment relationships, or changing the weighted constraints. At block 722, method 700 may apply the calibrated quality assessment for accelerating growth performance to one or more other financial events to thereby assess quality for the one or more financial events having a similar nature. In some cases, applying the calibrated quality assessments for accelerating growth performance may include using the calibrated quality assessments for accelerating growth performance as an investment goal to evaluate value of at least one of designs, plans, and portfolios. In the above example, the calibrated quality assessment for accelerating growth performance may be applied to a number of competing strategic sales plans for selection by the user and clients.

In some implementations, the methods and techniques described herein may allow for a redefinition of finding optimal plans and portfolios. The fundamental innovation may refer to scenarios where traditional goals, such as, e.g., shareholder value, may be combined with traditional constraints, such as, e.g., combining capital spending, operating costs, and production rates into a single quality assessment. For instance, in some cases, the methods and techniques described herein may provide boundaries as nearly sharp as linear optimization without making solutions difficult to identify. Further, the methods and techniques described herein may be capable of this by providing the ability to shape and weight factor-quality assessment relationship functions to provide significant penalties for certain factor values. This approach may thus allow for mimicking of linear constraints without introducing the challenge of finding various solutions for multiple constraints posed by linear optimization. Thus, the methods and techniques described herein may allow outcomes for optimization and consistent measure. This may be achieved by limiting the governing constraints to only those that are physical, and this approach may assure that a solution is found. In the case of product or project design, physical constraints may be defined as limitations applied to physical characteristics related to the design of a product or project. In the case of a plan or portfolio, the physical constraints may be defined as limitations applied to quantity, timing, and dependencies that govern either the activities or assets that are available for selection. By removing other non-physical constraints, such as levels of production, capital spend, and risk, from the optimization effort with this approach, solutions are more easily found. If solutions cannot be found, it will be due solely to violations of physical constraints which require resolution for a feasible solution. While the quality assessment value may not be to the user's desire, it may still be found. This result assures that constraints are not unsystematically adjusted or that underlying asset performance is inflated to find a linear solution.

In some implementations, the methods and techniques described herein may provide for improved portfolio selection. For instance, the user may embed goals and constraints as factors in the quality assessment of a portfolio design. In some cases, this may free the user to search for optimal physical combinations of assets with only physical constraints in governance to locate an overall optimal portfolio for a given use of factor-quality assessment relationships. Further, the methods and techniques described herein may provide for improved development of plan design. For instance, similar to portfolio selection, the user may also embed goals and constraints as factors in the quality assessment of a development plan design. This may allow the user to design an optimal development plan that may be only constrained by physical limits for the project, which sometimes may not be exceeded. This approach may allow for non-linear optimization of development plan designs, ranging from plants, projects, and/or business plans.

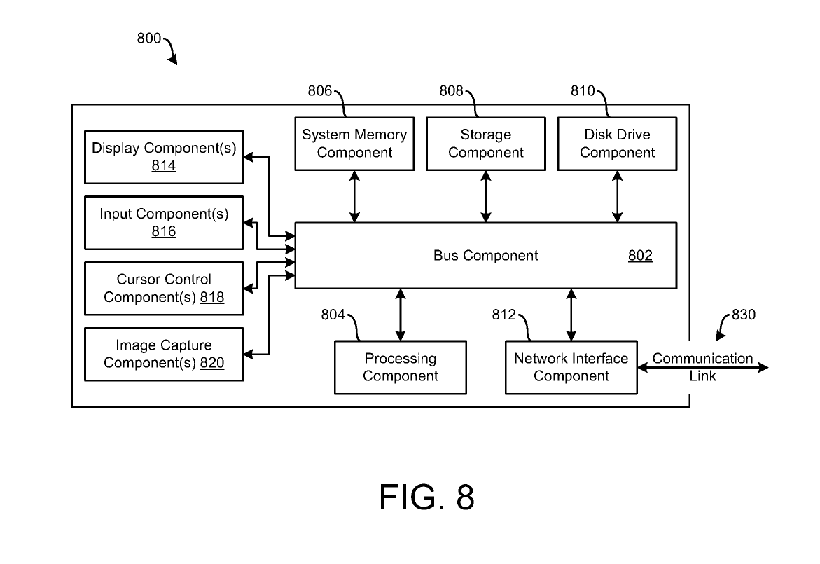

FIG. 8 illustrates a block diagram of a computing system 800 that is suitable for implementing various computers, computing devices, and/or other user based devices, such as, e.g., computing device 102 of FIG. 1. In some implementations, the computing device 102 may comprise a network communication device (e.g., mobile cellular phone, laptop, notebook, personal computer, etc.) capable of communicating with one or more other similar computing devices via a communication network.

In various implementations, the computer system 800 may includes a bus 802 and/or some other communication mechanism for communicating data and information, which interconnects subsystems and components, such as a processing component 804 (e.g., processor, micro-controller, digital signal processor (DSP), etc.), a system memory component 806 (e.g., RAM), a static storage component 808 (e.g., ROM), a disk drive component 810 (e.g., magnetic and/or optical), a network interface component 812 (e.g., transceiver, modem, or Ethernet card), a display component 814 (e.g., CRT or LCD), one or more input components 816 (e.g., keyboard, audio interface, voice recognizer, etc.), a cursor control component 818 (e.g., mouse or trackball), and an image or video capture component 820 (e.g., analog or digital camera). The disk drive component 810 may be a database having one or more disk drive components.

The computer system 800 may perform specific operations by the processing component 804 executing one or more sequences of one or more instructions stored in the system memory component 806. The instructions are read into the system memory component 806 from another computer readable medium, such as, e.g., the static storage component 808 and/or the disk drive component 810. In other embodiments, hard-wired circuitry may be used in place of or in combination with software instructions to implement various methods and techniques as described herein.

The computer system 800 may include logic that may be encoded in a computer readable medium, which may refer to any medium that participates in providing various instructions to the processor 804 for execution. Such a computer readable medium may take many forms, including but not limited to, non-volatile media and volatile media. In various instances, non-volatile media may include optical or magnetic disks, such as, e.g., the disk drive component 810, and volatile media may include dynamic memory, such as, e.g., the system memory component 806. In some instances, data and information related to executing instructions may be transmitted to the computer system 800 via transmission media, such as in the form of acoustic or light waves, including those generated during radio wave and infrared data communications. Transmission media may include coaxial cables, copper wire, and fiber optics, including wires that comprise the bus 802.

Some common forms of computer readable media may include a floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various implementations, execution of instruction sequences to practice the methods and techniques described herein may be performed by the computer system 800. In various other implementations, a plurality of computer systems 800 coupled by the communication link 830 (e.g., communication network, such as a LAN, WLAN, PTSN, and/or various other wired or wireless networks, including telecommunications, mobile, and cellular phone networks) may perform instruction sequences to practice the methods and techniques in coordination with one another.

The computer system 800 may transmit and/or receive data, information, and instructions, including messages pertaining to one or more programs (e.g., application code) via the communication link 830 and the communication interface 812. The program code may be executed by the processor 804 as received and/or stored in the disk drive component 810 or some other non-volatile storage component for execution.

Where applicable, various embodiments described herein may be implemented using hardware, software, or some combination of hardware and software. Also, where applicable, various hardware components and/or software components set forth herein may be combined into composite components comprising software, hardware, and/or both without departing from methods and techniques described herein. Further, where applicable, various hardware components and/or software components set forth herein may be separated into sub-components comprising software, hardware, or both without departing from methods and techniques described herein. In addition, where applicable, software components may be implemented as hardware components and vice-versa.

Software, in accordance with various embodiments described herein, such as program code, data, and/or other information, may be stored and/or recorded on one or more computer readable mediums. It is also contemplated that software identified herein may be implemented using one or more general purpose or specific purpose computers and/or computer systems, networked and/or otherwise. Where applicable, the ordering of various methods described herein may be changed, combined into composite methods, and/or separated into sub-methods to provide features described herein.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the following detailed description, numerous specific details are set forth to provide a thorough understanding of the disclosure provided herein. However, the disclosure provided herein may be practiced without these specific details. In some other instances, well-known methods, procedures, components, circuits and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
defining an event;
defining a quality assessment for the event;
defining factors for the event in association with the quality assessment;
characterizing a factor-quality assessment relationship between each factor and the quality assessment;
determining weighted constraints for applying to each factor-quality assessment relationship;
calibrating the quality assessment based on at least one of the factor-quality assessment relationships and the weighted constraints; and
applying the calibrated quality assessment to one or more other events.

2. The method of claim 1, wherein the event includes at least one of a health event, a safety event, a security event, and an environmental event.

3. The method of claim 1, wherein defining the event is based on user input, and wherein defining the quality assessment for the event is based on the user input.

4. The method of claim 1, wherein the event includes one or more events for which a user seeks to make the quality assessment, and wherein the quality assessment includes at least one of a characteristic, an attribute, and a quality of the event for the quality assessment.

5. The method of claim 1, further comprising translating the factor-quality assessment relationships into a quality assessment value, wherein calibrating the quality assessment is further based on the quality assessment value.

6. The method of claim 5, wherein translating the factor-quality assessment relationships includes defining a common curve based on user input by translating the characterized factor-quality assessment relationships into a common unit of measure.

7. The method of claim 6, wherein the common curve includes a first formula that translates the factors into a consistent set of values for input into the quality curve for a quality assessment value.

8. The method of claim 6, wherein translating the factor-quality assessment relationships includes defining a quality curve by translating the sum-product of the common curve for each factor-quality assessment relationship into the quality assessment value.

9. The method of claim 8, wherein the quality curve includes a second formula that aggregates sum-product translation results to provide a final assessment value.

10. The method of claim 1, wherein the weighted constraints are based on user input related to expert judgement of the user.

11. The method of claim 10, wherein calibrating the quality assessment is based on the weighted constraints related to the expert judgement of the user.

12. The method of claim 1, wherein calibrating the quality assessment is based on identifying adjustments to the factors and applying the adjustments to the factors based on user input, wherein the adjustments to the factors include one or more additional factors and replacement factors.

13. The method of claim 1, further comprising defining parameters for the factor-quality assessment relationship based on user input, wherein calibrating the quality assessment is based on identifying adjustments to the parameters and applying the adjustments to the parameters associated with one or more of the factor-quality assessment relationship and the weighted constraints.

14. The method of claim 1, wherein the one or more other events have a similar nature associated with the event.

15. A method, comprising:
defining an event based on user input;
defining a quality assessment for incident severity of the event based on the user input;
defining one or more contribution factors for the event in association with the quality assessment for incident severity based on the user input;
characterizing a factor-quality assessment relationship between each contribution factor and the quality assessment for incident severity based on the user input;
determining weighted constraints for multiple levels of incident severity for applying to each factor-quality assessment relationship, wherein the weighted constraints for each level of the multiple levels of incident severity are based on the user input related to expert judgement of the user;
calibrating the quality assessment for incident severity of the event based on the factor-quality assessment relationships and the weighted constraints for each level of the multiple levels of incident severity; and
applying the calibrated quality assessment to one or more other events to provide another quality assessment for incident severity of the one or more other events.

16. The method of claim 15, wherein the event includes at least one of a health event, a safety event, a security event, and an environmental event.

17. The method of claim 15, wherein the one or more other events have a similar nature associated with the event.

18. A method, comprising:
defining a financial event based on user input;
defining a quality assessment for accelerating growth performance associated with the financial event based on the user input;
defining condition factors for the financial event in association with the quality assessment for accelerating growth performance based on the user input;
characterizing a factor-quality assessment relationship between each condition factor and the quality assessment for accelerating growth performance based on the user input;
determining weighted constraints for multiple levels of accelerating growth performance for applying to each factor-quality assessment relationship, wherein the weighted constraints for multiple levels of accelerating growth performance are based on user input related to expert judgement of the user;
calibrating the quality assessment for accelerating growth performance based on the weighted constraints for the multiple levels of accelerating growth performance; and
applying the calibrated quality assessment for accelerating growth performance to one or more other financial events to thereby assess quality for the one or more financial events having a similar nature.

19. The method of claim 18, wherein the financial event includes one or more financial events for which a user seeks to make the quality assessment, and wherein the quality assessment includes at least one of a characteristic, an attribute, and a quality of the event for quality assessment.

20. The method of claim 18, wherein applying the calibrated quality assessments for accelerating growth performance includes using the calibrated quality assessments for accelerating growth performance as an investment goal to evaluate value of at least one of designs, plans, and portfolios.
